(19) United States
(12) Patent Application Publication
(10) Pub. No.: US 2007/0192277 A1
(43) Pub. Date: Aug. 16, 2007

(54) Personalized concierge system with optimized user interface

(76) Inventor: Timothy R. Jackson, Yorba Linda, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/701,814

(22) Filed: Feb. 1, 2007

Related U.S. Application Data
(60) Provisional application No. 60/763,868, filed on Feb. 1, 2006.

(51) Int. Cl. G06F 17/30

(52) U.S. Cl. 707/1

(57) ABSTRACT

The present invention relates to a system, apparatus and method for implementing a personalized concierge system with an optimized user interface. The present invention adds significant value relative to prior-art LBS systems by providing a group of features that simplifies use of the system, provides personalized search capability, and supports communication of information to other people.

### PRIORITY CLAIMS

The present utility patent claims priority to the earlier filed United States Provisional Patent Application, filed on Feb. 1, 2006 and issued Ser. No. 60/763,868.

### FIELD OF THE INVENTION

The invention relates generally to a method and apparatus for implementing a personalized concierge system. More specifically, the present invention relates to a method and apparatus for implementing a personalized concierge system that provides search results from a database, the search results being filtered according to a plurality of criteria.

### BACKGROUND OF THE INVENTION

Location based service (LBS) systems are databases of activities (such as dining, entertainment, sports, etc.) that users can search in order to find something to do. For instance, a user may be traveling in a new city without knowledge of restaurants in the area. With access to an LBS system the user can query the system for restaurants near his/her present location.

Existing LBS systems allow users to input location data and keywords in order to perform a search of the LBS database. Some LBS systems require that the user input their present location while newer systems are able to receive location data from global positioning system (GPS) apparatus or other location technology devices. All LBS systems require that the user enter keywords each time they perform a search. This results in significant amounts of user input and is therefore most effective when using a computer keyboard and pointing device. Such LBS systems are more difficult to use when attempting access using a device with a more limited user interface such as a cell phone. The prior art LBS systems typically provide a focused search that is initiated based on a top-level category such as ‘Dining’, ‘Nightclub’, ‘Sports’, etc. Additional keywords (such as ‘Chinese, ‘Steakhouse’, ‘Italian’ etc.) can be input by the user in order to further refine the search.

This search capability may be acceptable when the user knows the exact activity he/she is looking to be involved in. However, the search capability is much less efficient when the user does not have a particular activity or plan in mind.

In the latter case the user may be required to input information into the LBS system multiple times and perform multiple searches in order to find an activity of interest. It is important to emphasize that the more system input required of the user, the less efficient the LBS system will be when accessed by devices with limited I/O capability (i.e. cell phones.) The prior art LBS systems typically have limited (if any) memory of the user's transactions therefore each time the user commences a new search they must re-enter information.

However, a problem with many of these prior art search systems is that they have very limited memory of the user's past transaction and require the user to re-enter information to make a similar or the same request.

Additionally, another problem that exists is that the prior are LBS system may require the user to make multiple search requests to determine an appropriate activity which is extremely time consuming and laborious.

Accordingly, a need therefore still exists for an improved location based system that allows the user to quickly and efficiently find and determine interesting activities suited for their needs.

Moreover, a need therefore exists for an improved personalized concierge system that provides a plurality of search results based on a variety of search criteria.

Further, a need therefore still exists for an improved personalized concierge system that may filter search data to the user based on a plurality of search criteria entered by the user for determination of an appropriate activity.

### SUMMARY OF THE INVENTION

To minimize the limitations in the prior art, and to minimize other limitations that will become apparent upon reading and understanding the present specification, the present invention discloses a method and system/apparatus for implementing a personalized concierge system with multiple services and an optimized user interface.

To this end in an exemplary embodiment of the present invention, a system for providing personalized concierge services is provided. The system has a database for performing searches, said searches utilizing a plurality of search criteria. Additionally, the system has a database search algorithm and a user interface for interaction between an end user and the database.

In an exemplary embodiment, a system for providing personalized concierge services is provided wherein the plurality of search criteria comprises utilizing time information, location information and personal preference information as elements in the database search algorithm.

In an exemplary embodiment, a system for providing personalized concierge services is provided wherein data in the database can be populated by administrators of the system.

In an exemplary embodiment, a system for providing personalized concierge services is provided wherein data in the database can be populated by users of the system.

In an exemplary embodiment, a system for providing personalized concierge services is provided wherein access to the system can be achieved through wired device.

In an exemplary embodiment, a system for providing personalized concierge services is provided wherein access to the system can be achieved through the use of a wireless device.

In an exemplary embodiment, a system for providing personalized concierge services is provided wherein access to the system can be achieved through a remote communication mechanism.

In an exemplary embodiment, a system for providing personalized concierge services is provided wherein the system has a database administration tools screen which qualifies a specific user after authorization data is input into the system by the user.

In an exemplary embodiment, a system for providing personalized concierge services is provided wherein information relating to the user's present location can be input into the database and can be determined with the help of GPS technology and the information utilized by the database search algorithm.

In an exemplary embodiment, a system for providing personalized concierge services is provided wherein information relating to real time and user inputted time information is utilized by the database search algorithm.

In an exemplary embodiment, a system for providing personalized concierge services is provided wherein the system builds a personal profile of the user from the inputted data and from selected data to define the user's preferences.

In an exemplary embodiment, a system for providing personalized concierge services is provided wherein the system has a contact address book containing contact information for other individuals. Additionally, the system has group lists that combine a plurality of contact information from other individuals wherein the system compiles information from the plurality of individuals and determine potential compatibility between the individuals.

To this end in an exemplary embodiment of the present invention, a method for providing personalized concierge services is provided. The method comprises the steps of: providing a user database for performing searches, said searches utilizing a plurality of search criteria; providing a database search algorithm designated to utilize the plurality of search criteria results from the user and search the database for corresponding relevant information relating to the search criteria; and providing a user interface whereby the user utilizes the user interface to access the database and to input search criteria.

In an exemplary embodiment, a method for providing personalized concierge services comprises the further step of: allowing the database search to be initiated by a single user interaction with the user interface.

In an exemplary embodiment, a method for providing personalized concierge services comprises the further step of: providing an input device that can be assigned pre-determine parameters.

In an exemplary embodiment, a method for providing personalized concierge services comprises the further step of: providing an input device for interaction with the database whereby the input device is assigned to a user based on personal information input by the user.

In an exemplary embodiment, a method for providing personalized concierge services comprises the further step of: activating an input device which initiates the database search algorithm to search the database using: location information, time information, personal information, and information assigned to the input device.

In an exemplary embodiment, a method for providing personalized concierge services comprises the further step of: allowing the database to return a list of activities that best match any combination of: location information, time information, personal information, and information assigned to an input device.

In an exemplary embodiment, a method for providing personalized concierge services comprises the further step of: the algorithm providing local traffic information in order to estimate travel time from the location of the user to the location of the activities returned by the database search.

In an exemplary embodiment, a method for providing personalized concierge services comprises the further step of: allowing the user to send information relating to at least one of the activities returned by the database search to a contact stored in an address book.

In an exemplary embodiment, a method for providing personalized concierge services comprises the further step of: providing a calendar management capability that results from the database search.

In an exemplary embodiment, the present invention provides a system and method of providing a personalized concierge service.

In yet another exemplary embodiment, the present invention provides a system and a method for providing a personalized concierge service which may utilize an optimized user interface for cell phone applications.

Yet another exemplary embodiment of the present invention provides a system and a method of providing a personalized concierge service whereby the system may utilize an optimized user interface for computer applications.

Still another exemplary embodiment of the present invention provides a system and a method of providing a personalized concierge service whereby the system may allow the user of the system to input activities into the system database.

Another exemplary embodiment of the present invention provides a system and a method of providing a personalized concierge service whereby the system may allow the user of the system to create a personalized profile.

Yet another exemplary embodiment of the present invention provides a system and a method of providing a personalized concierge service whereby the system may utilize personal profile information for optimized searches.

A further exemplary embodiment of the present invention provides a system and a method of providing a personalized concierge service whereby the system may utilize personal profile information as a means to optimize the user interface.

In yet another exemplary embodiment of the present invention, a system and method is provided for personalized concierge service whereby the system may allow the user to quickly communicate local activities to other people.

Still another exemplary embodiment of the present invention provides a system and a method of providing a personalized concierge service whereby the system may provide users with a calendar management function.

Yet another exemplary embodiment of the present invention provides a system and a method of providing a personalized concierge service whereby the system may provide an end user with optional match-making service, with other compatible users of the system.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 illustrates one possible Top-level System Diagram in an exemplary embodiment of the present invention;

FIG. 2 illustrates a User Interface in an exemplary embodiment of the present invention;

FIG. 3 illustrates a Query Interface in an exemplary embodiment of the present invention; and

FIG. 4 illustrates a Top-level Flow Diagram of the system operation in an exemplary embodiment of the present invention.

### DETAILED DESCRIPTION

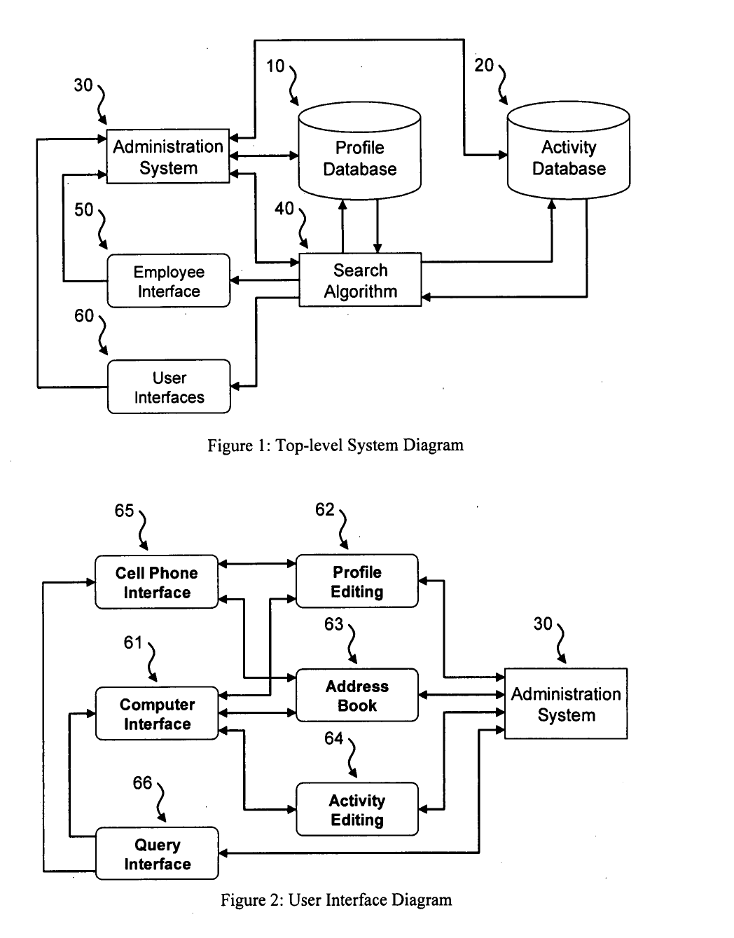

Turning now to the drawings wherein elements are identified by numbers and like elements are identified by like numbers throughout the 4 figures, the invention is depicted in FIG. 1 and illustrates a personalized concierge system.

The following description of the preferred embodiment of the present invention makes reference to the included drawings which form a part hereof. Said drawings show by way of illustration a specific embodiment in which the invention may be implemented. It is not intended in any way that said illustrations limit the scope of the invention to only the embodiment described herein. The present invention is also expected to be embodied in other forms not specifically addressed in the illustrations that form a part of this description.

The present invention provides a personalized concierge service to subscribers/users of the system illustrated in FIG. 1. The included embodiment of the present invention is comprised of several components (as illustrated in FIG. 1), namely the Activity Database (10), the User Profile Database (20), the Administration System (30), the Search Algorithms (40), the Employee Interface (50), and the User Interface (60). Each component of the present invention is described herein below.

Activity Database (10)—The Activity Database (10) is a massive database that contains specific information about a wide variety of activities, services, events for all cities and towns covered by the service. Such activities, services, events include (but are not limited to) restaurants, night clubs, sporting events, movies, theater, cultural activities, religious activities, etc. Information is populated into the Activity Database (10) utilizing either the User Interface (60) or the Employee Interface (50). Queries can be made to the Activity database in order to determine what activities, services, and/or events are available at a given locale in a given timeframe.

Profile Database (20)—The Profile Database (20) is a massive database that contains specific information about each user/subscriber of the concierge service. Such information may include (but is not limited to) the user's name, contact information, address, birth date and activity preferences. Information is populated into the Profile Database utilizing either the User Interface (60) or the Employee Interface (50). Data from the Profile Database (20) is used by the Search Algorithm (40) in order to perform personalized searches of the Activity Database (10).

Administration System (30)—The Administration System (30) manages the entire system. All interaction between system users and the system databases is managed and controlled via the Administration System (30).

Search Algorithm (40)—The Search Algorithm (40) is used to perform searches on the Activity Database (10) and/or the Profile Database (20) depending on the feature or function requested by a given user. The Search Algorithm (40) can utilize personal information from the Profile Database (20), information relating to the user's location, and information relating to the user's chosen timeframe in order to perform a personalized search of the Activity Database (10). The Search Algorithm (40) can also perform comparative searches within the Profile Database (20) in order to determine potential compatibility between users of the system.

Employee Interface (50)—The Employee Interface (50) is used to give employees access to the system.

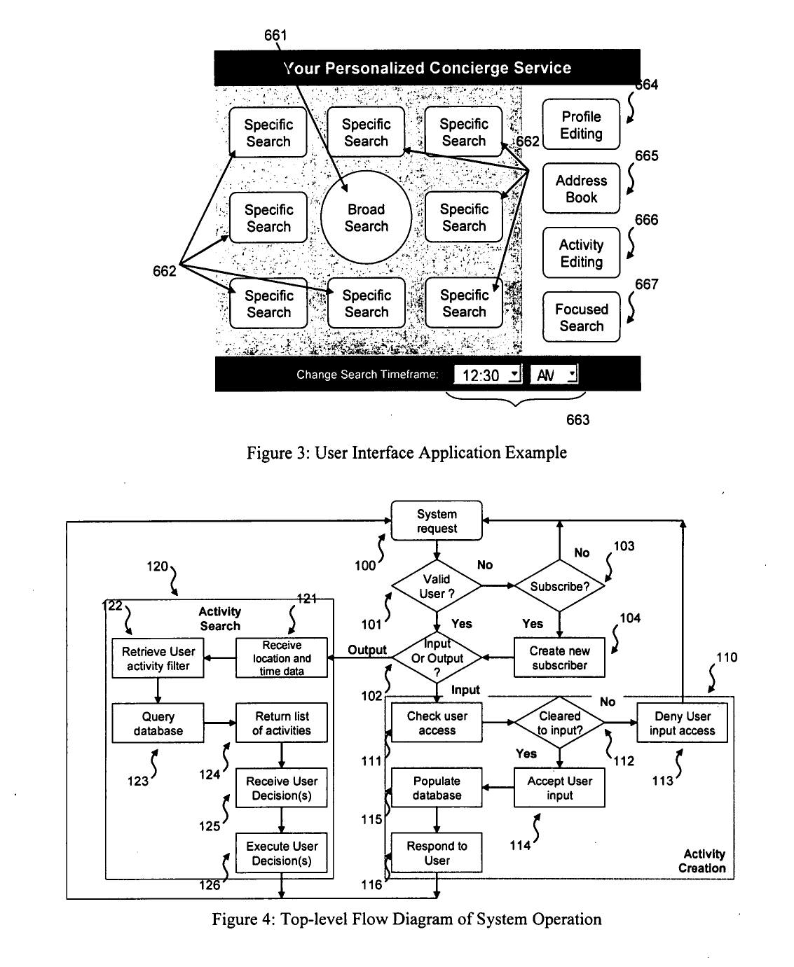

User Interface (60)—The User Interface (60) is used to give users/subscribers of the service access to the system. FIG. 2 illustrates one embodiment of the User Interface (60). The User Interface (60) can have multiple interface types. In the embodiment illustrated in FIG. 2, a Computer Interface (61) and a Cell Phone Interface (65) are provided. An example of an embodiment of a User Interface Application is illustrated in FIG. 3. The User Interface (60) may include the following interfaces:
1) Computer Interface (61): The Computer Interface (61) is typically used when significant amounts of user interaction are required, such as populating data into the Activity Database (10) and/or Profile Database (20). The availability of a keyboard and pointing device on most computers renders the Computer Interface (61) more efficient for such high input tasks.
2) Profile Editing (62): The Profile Editing (62) function is the user's interface to the Profile Database (20). The Profile Editing (62) function allows a user to input and edit information about that user such as name, contact information, address, birth date and activity preferences. Using the Profile Editing (62) function the user can input as many activity preferences as desired.
3) Address Book (63): The Address Book (63) function is used to create and edit contact information for other individuals or groups that the user may desire to contact using the system. Information that is input via the Address Book (63) function is stored in the Profile Database (20). The Address Book (63) function also allows users to create group lists wherein all members of a given group can be contacted simultaneously by invoking the name assigned to that given group.
4) Activity Editing (64): The Activity Editing (64) function allows users to create and edit activities for the Activity Database (10). The Activity Editing (64) function allows a user to create a new activity and provide information on that activity which may include (but is not limited to): location, contact information, category and sub-categories, written description, cost/price information, and time information.
5) Cell Phone Interface (65): The Cell Phone Interface (65) may provide access to all or part of system functions that are accessible through the Computer Interface (61), however the Cell Phone Interface (65) is typically optimized to provide the most efficient operation on the limited keypad found on most cell phones.
6) Query Interface (66): The Query Interface (66) allows users to retrieve information from the Activity Database (10) and/or Profile Database (20). One possible embodiment of the Query Interface (66) is illustrated in FIG. 3. The Query Interface (66) may provide a set of input devices (physical and/or graphical) that the user may activate in order to initiate functions of the system. On the Query Interface (66) illustrated in FIG. 3, the input devices (or ‘buttons’) are graphical entities represented on a computer display and/or cell phone display. A Broad Search (661) button is provided such that a broad search of the Activity Database (10) can be initiated when this button is activated. A set of Specific Search (662) buttons are also provided. Each of the Specific Search (662) buttons can be assigned a specific activity such as dining, sports, religion, etc. The assignment of a specific function to a given Specific Search (662) button can be either static or dynamic. Dynamic allocation of a specific activity to a Specific Search (662) button is a key advantage of the present invention relative to prior art as this allows the Query Interface (66) to dynamically adapt to fit the personal preferences of each user. Activating a Specific Search (662) button will initiate a search of the Activity Database (10) that is focused to the particular activity function assigned to that Specific Search (662) button. The Query Interface (66) may also include Time Input (663) controls that allow the user change the timeframe parameters utilized during a search of the Activity Database (10). A Focused Search (667) button allows the user to input additional information prior to initiating a database query resulting in a more focused search.
   As previously mentioned, the User Interface (60) can be implemented in a variety of ways. The embodiment described herein is in no way meant to limit the options for implementation.
   System Operation
   The personalized concierge service implemented by the present invention is employed by users in order to ascertain information about a wide variety of activity options available in a given locale.
   The Top-level flow of the present invention is illustrated in FIG. 4. A user initiates a system request (100) using the User Interface (60). The Administration System (30) then verifies that the user is a valid user (101) to determine if access will be granted to the system. If the System Administration (30) determines the user is not valid, the user is presented with the option to subscribe (103). If the user chooses to subscribe (103) anew user/subscriber is created (104) in the Profile Database (20). If the user decides not to subscribe, the session is cancelled and the system becomes available for another system request (100).
   Once the user is verified as valid (101) or a new user is created using the subscribe (104) function, the valid user is granted access to the system. The user then decides if they will initiate an input function to or an output function from (102) the system.
   User Interface System Input Functions—The User Interface (60) allows a user to input data to the Activity Database (10) and/or the Profile Database (20). The Administration System (30) first checks to see if the user has access privileges (111) to the system. For Profile Editing (62) or Address Book (63) editing the user is automatically granted access. For Activity Editing (64) the Administration System (30) verifies that the user has a good rating based on previous Activity Editing (64) sessions. If the user's rating is not good (113), the Activity Editing (64) access is denied and the system awaits another system request (100). Input to a system database is typically performed using the Computer Interface (61) due to the significant amounts of user interaction required. The availability of a keyboard and pointing device on most computers renders the Computer Interface (61) more efficient for such high input tasks. The system will support input to a database using the Cell Phone Interface (65) via a cell phone keypad however the efficiency may be much lower.
1. Profile Editing (62): Typically the first action a new user/subscriber will take is to access the Profile Database (20) using the Profile Editing (62) function in order to edit his/her personal information. In the illustrated embodiment, the Profile Editing (62) function is initiated by clicking the Profile Editing (664) button on the User Interface Application screen (FIG. 3.) Using Profile Editing (62) the user will input information such as name, contact information, address, birth date, and activity preferences. The user can input information on as many preferred activities as necessary in order to provide the most accurate profile of that user's interests and preferences. The user can rank the preferred activities in his/her personal profile such that the activities of highest interest will appear at the top of the list when a search of the Activity Database (10) is performed.
2. Address Book (63): In addition to creating a personal profile, the user can also input data into the Profile Database (20) by using the Address Book (63) function to record contact information for friends/associates. The Address Book (63) function can also import existing contact information from other sources such as email systems. As with most address book systems, the Address Book (63) function of the present invention allows users to create group lists by including one or more contact names on a list and assigning that list a unique name. This group list feature is important for the present invention as it allows the user to send information regarding a chosen activity to multiple contacts simultaneously using a single button click. This feature, known as ‘Friend SendM’ will be discussed in more detail later in this document. The Address Book (665) button on the User Interface Application (FIG. 3) is used to enable the Address Book (63) editing function.
3. Activity Editing (64): Provided that a user has a good rating, that user will be allowed to create an activity record for the Activity Database (10) using the Activity Editing (64) function. The Activity Editing (64) function allows a user to input a variety of information such as the name of the activity, its location, contact information, prices, event times, and description. The Activity Editing (64) function is typically employed by users that are associated with an event or activity and desire to expose the event or activity to a wider audience. For example, a user may be associated with a rowing club that is interested in expanding its membership. That user can input information about the rowing club into the Activity Database (10) via the Activity Editing (64) function. A key feature of the Activity Editing (64) function is that it allows the user to set access privileges for the event or activity. An application where the access control function is of value is a university concierge service in which the university desires to limit access to the Activity Database (10) to only those users with a valid student ID. Once the user completes the entry of an event or activity the Administration System (30) checks the input content (114) to verify compliance with the system rules (language, protocol, etc.) If the check is successful the information is recorded (115) to the Activity Database (10) and the system provides a confirmation response (116) to the user. The user may continue to populate a new activity to the Activity Database (10) or they may opt to exercise a different function of the system. The Activity Editing (666) button on the User Interface Application (FIG. 3) is used to enable the Activity Editing (64) function.
   User Interface System Output Functions—The User Interface (60) allows a user to output data from the Activity Database (10) and/or the Profile Database (20) via the Query Interface (66). The primary function of the present invention is to allow users to query the Activity Database (10) however the user may also query the Profile Database (20) in order to find other users that have similar interests and preferences. The User Interface (60) has interface provisions to suit a variety of user terminal devices, such as computers and cell phones. The Computer Interface (61) is designed to take advantage of the full keyboard and pointing device typically available on computing platforms. The Cell Phone Interface (65) is designed to provide optimal efficiency when used with the limited keyboard of a cell phone platform. Additional interfaces can be implemented for smart phones and personal data assistants (PDA.)
1. One Button Search™: To initiate an Activity Search (120), the Query Interface (66) is employed. There are two options for performing an Activity Search (120). The first option is called the One Button Search™ (OBS.) The OBS allows a user to query the Activity Database (10) using a single click on one of the buttons provided on the Query Interface (66). When the OBS function is initiated, the system collects information on the user location and time (121) and provides that information to the Search Algorithm (40). The Search Algorithm (40) also retrieves the user's personal profile information (122) from the Profile Database (20) and performs a query (123) of the Activity Database (10) based on this collection of information. If the Broad Search (661) button is activated the Search Algorithm (40) performs a broad search (123) of all activities in the Activity Database (10.) If a Specific Search (662) button is activated the Search Algorithm (40) focuses the query (123) to only those records in the Activity Database (10) that match the activity assigned to the Specific Search (662) button. By utilizing the information from the Profile Database (20) and the function assigned to each button in the Query Interface (66), the system can perform an Activity Search (120) without the need for the user to input additional information. This is a key advantage of the present invention relative to prior art as it significantly increases the efficiency of the system when accessed through cell phones and other devices with limited input resources. When the Search Algorithm (40) completes its query (123) of the Activity Database (10) all records that match the search criteria are returned (124) for display on the User Interface (60.)
2. Focused Search: The focused search allows a user to input more information in order to perform a more focused query of the Activity Database (10.) The user enables the focused search function by activating the Focused Search (667) button on the User Interface Application (FIG. 3.) In this mode the user can input a variety of information such as travel time, travel distance, price/cost, time, activity categories, activity description, etc. relating to this specific search. When the user finishes inputting information a focused search can be initiated whereby the system collects information on the user location and time (121) and provides that information to the Search Algorithm (40). The Search Algorithm (40) then retrieves the user's personal profile information (122) from the Profile Database (20) and the focused search information as input by the user. The system then performs a query (123) of the Activity Database (10) based on this collection of information. When the Search Algorithm (40) completes its query (123) of the Activity Database (10) all records that match the search criteria are returned (124) for display on the User Interface (60.)
3. Profile Matching: Profile matching is a unique feature of the present invention relative to prior-art LBS systems. The profile matching feature allows users to request a query of the Profile Database (20) wherein the system compares that user's personal profile data to other users' personal profile data. This allows a user to search for other users that may share similar interests. During the creation and/or editing of a user's personal profile, the user can choose the option to allow that user's personal profile information to be queried for comparison. If the user does not enable this option, that user's personal profile data will not be compared when another user initiates a profile matching query.
   Once the system returns information (124) from a database query the user must then make a decision as to the next course of action (125.) Typically the user will select one (or more) of the activities returned from the Activity Database (10) by the Search Algorithm (40.) Upon selecting an activity the user will be given several options on how to proceed. Some of the options available to the user are:
Make reservations (if remote reservation capability is supported by the activity provider),
Purchase tickets (if remote purchase capability is supported by the activity provider),
Get travel directions
Calculate travel time based on present traffic information
Communicate activity options to other people
   A unique and significant feature of the present invention is the ability to communicate activity options to other people. This feature (designated ‘Friend Send’™) gives the user the capability to transmit information on a chosen activity to a person and/or group whose contact information is stored in Profile Database (20.) This feature allows people to remotely coordinate activities.
   Use Example of the Present Invention

To best illustrate the value of the present invention, the following use example is provided. A group of families is participating in a soccer tournament hosted away from their home town. After the last game of the day, the families desire to coordinate a group dinner. One (or more) of the families is a valid user of the present invention. Using a cell phone, the user accesses the User Interface Application (FIG. 3) and sets the Time Input (663) to 7:00 PM. The user then requests a One Button Search™ of the Activity Database (10) using the Specific Search (662) button that is labeled ‘Dining.’ The Administration system provides the time information from the Time Input (663), the user's present location gathered from the cellular network, and the personal profile information from the Profile Database (20) that relates to ‘Dining’ to the Search Algorithm (40.) The Search Algorithm (40) performs a query (123) of the Activity Database (10) and returns the query results (124) on the User Interface (60) of the cell phone. Upon receiving the search results (124) the user selects two of the dining options. The user then selects the Friend Send™’ option and chooses the group list named ‘Soccer Team’. The system simultaneously sends the information on the two dining options to the appropriate contact numbers listed in the user's address book stored in the Profile Database (20.) When the user receives consensus on the dining establishment of choice, he then selects the option to make reservations. By virtue of the unique elements of the present invention, the entire activity is accomplished with minimum user interaction with the cell phone keyboard.

It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed:

1. A system for providing personalized concierge services, the system comprising:
a database for performing searches, said searches utilizing a plurality of search criteria;
a database search algorithm; and
a user interface for interaction between an end user and the database.

2. The system described in claim 1 wherein the plurality of search criteria comprises utilizing time information, location information and personal preference information as elements in the database search algorithm.

3. The system described in claim 1 wherein data in the database can be populated by administrators of the system.

4. The system described in claim 1 wherein data in the database can be populated by users of the system.

5. The system described in claim 1 wherein access to the system can be achieved through wired device.

6. The system described in claim 1 wherein access to the system can be achieved through the use of a wireless device.

7. The system described in claim 1 wherein access to the system can be achieved through a remote communication mechanism.

8. The system described in claim 1 further comprising:
a database administration tools screen which qualifies a specific user after authorization data is input into the system by the user.

9. The system described in claim 1 wherein information relating to the user's present location can be input into the database and can be determined with the help of GPS or other location technology and the information utilized by the database search algorithm.

10. The system described in claim 1 wherein information relating to real time and user inputted time information is utilized by the database search algorithm.

11. The system described in claim 1 wherein the system builds a personal profile of the user from the inputted data and from selected data to define the user's preferences.

12. The system described in claim 1, further comprising:
a contact address book containing contact information for other individuals; and,
group lists that combine a plurality of contact information from other individuals.

13. The system described in claim 11 wherein the personal profile of the user may be compared to profiles of different users to determine potential compatibility between the users.

14. The system describe in claim 1 wherein a calendar management capability is included such that the results from a database search is transferred to the calender.

15. The system described in claim 1 wherein time information may be compared to a calendar to determine if conflicts exist with other calendar entries and potential search dates.

16. The system described in claim 1 wherein the system allows for selection of an activity returned by the system and designates the activity as the geographic reference point for subsequent database searches.

17. The system described in claim 1 wherein a user builds an agenda using a referenced activity and searches for subsequent activities related to the reference activity.

18. The system described in claim 1 wherein a detailed map of the are around a referenced activity is rendered by the system and locations and details of subsequent activities on an agenda are included on the detailed map.

19. A method for providing personalized concierge services, the method comprising the steps of:
providing a user database for performing searches, said searches utilizing a plurality of search criteria;
providing a database search algorithm designated to utilize the plurality of search criteria results from the user and search the database for corresponding relevant information relating to the search criteria; and
providing a user interface whereby the user utilizes the user interface to access the database and to input search criteria.

20. The method described in claim 19, the method further comprising the step of:
allowing the database search to be initiated by a single user interaction with the user interface.

21. The method described in claim 19, the method further comprising the step of:
providing an input device that can be assigned pre-determine parameters.

22. The method described in claim 19, the method further comprising the step of:
providing an input device for interaction with the database whereby the input device is assigned to a user based on personal information input by the user.

23. The method described in claim 19, the method further comprising the step of:
activating an input device which initiates the database search algorithm to search the database using: location information, time information, personal information, and information assigned to the input device.

24. The method described in claim 19, the method further comprising the step of:
allowing the database to return a list of activities that best match any combination of: location information, time information, personal information, and information assigned to an input device.

25. The method described in claim 19, the method further comprising the step of:
the algorithm providing local traffic information in order to estimate travel time from the location of the user to the location of the activities returned by the database search.

26. The method described in claim 19, the method further comprising the step of:
allowing the user to send information relating to at least one of the activities returned by the database search to a contact and/or a plurality of contacts stored in an address book.

27. The method described in claim 19, the method further comprising the step of:
providing a calendar management capability that results from the database search.
